(19) United States
(12) Patent Application Publication
(10) Pub. No.: US 2007/0165645 A1
(43) Pub. Date: Jul. 19, 2007

(54) Method, system, content server, GGSN, and SGSN for switching traffic during real time stream transmission

(75) Inventors: Yanqiang Zhang, Shenzhen (CN); Weigang Qiu, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/652,906

(22) Filed: Jan. 10, 2007

(30) Foreign Application Priority Data
Jan. 13, 2006 (CN) 200610001153.3

(51) Int. Cl. H04L 12/56; H04L 12/28

(52) U.S. Cl. 370/395.2; 370/400

(57) ABSTRACT

A method for switching traffic during real time stream transmission depends on a network side device to identify the start and end of the stream transmission, and to perform a switching between Best Effect traffic and the streaming traffic. The network side device can be a stream media content server, a Serving General Packet Radio Service (GPRS) Support Node (SGSN) or a Gateway General Packet Radio Service Supporting Node (GGSN) of a Core Network (CN). A system for switching traffic during a real time stream transmission, a content server for real time stream transmission, a GGSN for real time stream transmission, an SGSN for real time stream transmission are also disclosed.

### CROSS-REFERENCE TO RELATED APPLICATION

This application claims the priority benefit of Chinese Patent Application No. 200610001153.3, filed Jan. 13, 2006, the entire disclosure of which is hereby incorporated herein by reference.

### BACKGROUND OF THE INVENTION

1. Field of the Invention

The invention relates to mobile communication technologies, and more particularly, to a method and a system for switching traffic when transmitting a real time stream, and a content server for real time stream transmission, a Gateway General Packet Radio Service Supporting Node (GGSN) for real time stream transmission and a Serving General Packet Radio Service (GPRS) Support Node (SGSN) for real time stream transmission.

2. Related Technology

The most notable feature of the third generation (3G) mobile communication system is that a higher data transmission rate can be supported, and a reasonable type of data transmission bearer traffic can be allocated according to a specific Quality of Service (QoS) requirement of application traffic, to meet the QoS requirement or the application traffic. The data transmission traffic of the 3G system can be divided into four categories according to different QoS requirements: conversational traffic, streaming traffic, interactive traffic and background traffic. The interactive traffic and the background traffic can be jointly called Best Effort (BE) traffic. The conversation traffic requires certain transmission bandwidth to be allocated, and has a strict requirement on the delay of data transmission. The conversational traffic is mainly used as the bearer of application traffic such as voice and video phone communications. The streaming traffic requires less data transmission delay and higher transmission bandwidth, and is mainly used as the bearer of the application traffic of playing multimedia. The BE traffic is mainly used as the bearer of the application traffic, such as webpage browsing, Email and background downloading, with low requirement on the time delay and the transmission bandwidth. The stream is called the real time stream as well, and the 3rd Generation Partnership Project (3GPP) defines the stream as the data which can be continuously played in the application layer while being transferred from the network to the client, such as video, audio and voice. In a commercial mobile network, the stream media traffic has become a profitable focus of the operator, therefore more and more attention is paid to the stream media traffic.

Usually, the stream and the stream link address are both placed in a special stream content server. The user first visits a server webpage having multiple stream program sources, and then the user can select and click a program source on the webpage to receive the corresponding stream according to his interest. The access to the server webpage is an interactive process without rate and time delay requirement, which adopts a BE traffic bearer; while the access to the stream requires a switch from a transmission bearer to a stream bearer. After the access to stream is terminated, the transmission bearer should be switched back to the BE traffic bearer.

In existing commercial applications, the key technical problem of switching the transmission bearer is avoided, and no switching between the BE traffic and the streaming traffic is performed, and the BE traffic is used to bear the playing of stream media. The BE traffic sets no requirement on time delay and jittering, and considering the actual network capacity and coverage in application, the BE traffic employs some algorithms in favor of features of BE traffics, such as dynamic channel bandwidth re-configuration, downlink rate re-configuration based on the downlink code transmitting power, so that no guarantee can be provided for the playing of stream media.

The method for traffic switching prescribed by the 3GPP is that: a terminal identifies a stream, and notifies a Core Network (CN) to initiate and set up a stream transmission bearer. Specifically speaking, a content server and the terminal transmit the interactive information first during the stream transmission, i.e., the content server transmits a Session Description Protocol (SDP) file to the terminal. The file is not used to transmit the stream content but to transmit some messages to control the stream. The terminal analyzes the SDP file and notifies the CN to set up a transmission bearer suitable for the QoS attributes. After the bearer channel is set up, the server can be notified to start content transmission through a PLAY signaling, and can be notified to stop the transmission through a TEARDOWN signaling.

The method specified by the 3GPP protocol requires the terminal to identify the stream and initiate a negotiation process to the CN, which is not supported at present by many commercial terminals. In addition, a terminal is often used as a wireless gateway to transmit the stream in practical applications, but a wireless gateway is only a channel without the capability of identifying the stream. Because the method specified by the 3GPP protocol sets too high requirement on the terminals, the popularization and application of the method are limited to a great extent.

### SUMMARY OF THE INVENTION

Embodiments of the invention provide a method and a system for switching traffic during the real time stream transmission, to provide QoS guarantee for the playing of the stream media. Since it is not necessary for the terminal to identify the stream, the method can be easily popularized and applied. A content server for real time stream transmission, a GGSN for real time stream transmission and an SGSN for real time stream transmission are also provided by the embodiments of the invention.

The method includes the following processes:
upon identifying a start of stream transmission from a content server to a terminal, a network side performs a traffic switching from a BE traffic to a streaming traffic, and
upon identifying an end of stream transmission from the content server to the terminal, the network side performs a traffic switching from the streaming traffic to the BE traffic.

The identifying the start and end of stream transmission from a content server to a terminal are preferably implemented by the content server;
the process of the network side performing the traffic switching from the BE traffic to the streaming traffic includes: upon receiving a request for the stream transmission from the terminal and identifying the start of the stream transmission, send a request for setting up a streaming traffic bearer to an SGSN of a CN; upon receiving the request, send a request for switching a bearer channel from the BE traffic to the streaming traffic to a Radio Network Control (RNC) of an access network; upon receiving the request, interact with the terminal to switch the bearer channel from the BE traffic to the streaming traffic;
the process of the network side performing a traffic switching from the streaming traffic to the BE traffic includes: upon receiving signaling indicating the end of stream transmission from the terminal and identifying the end of the stream transmission, send a request for setting up a BE traffic bearer to the SGSN of the CN; upon receiving the request, send a request for switching the bearer channel from the streaming traffic to the BE traffic to the RNC of the access network; upon receiving the request, interact with the terminal to switch the bearer channel to the BE traffic.

Preferably, the signaling indicating the end of stream transmission is a TEARDOWN signaling of the real time stream protocol.

Preferably, before sending the request for setting up a streaming traffic bearer to the SGSN of the CN, obtain the QoS requirements of the stream transmission from a session description protocol file corresponding to the stream, and contain the QoS requirements being contained in the request for setting up the streaming traffic bearer.

The identifying the start and end of stream transmission from a content server to a terminal is preferably implemented by a network element of the CN;
the process of the network side performing a traffic switching from a BE traffic to a streaming traffic includes: determine whether content of a network packet sent to the content server is a signaling indicating the start of the stream transmission, if the content of the network packet is the signaling indicating the start of the stream transmission, send a request for switching a bearer channel from a BE traffic to a streaming traffic to an RNC of an access network; upon receiving the request for switching the bearer channel, interact with a terminal to switch the bearer channel from the BE traffic to the streaming traffic.

The process of the network side performing a traffic switching from the streaming traffic to the BE traffic preferably includes: determining whether content of the network packet sent to the content server is a signaling indicating the end of the stream transmission, if the content of the network packet is the signaling indicating the end of the stream transmission, send a request for switching the bearer channel from the streaming traffic to the BE traffic to the RNC of the access network; upon receiving the request for switching the bearer channel, interact with the terminal to switch the bearer channel to the BE traffic.

Preferably, determining whether the content of the network packet is signaling indicating the start of the stream transmission includes: determine whether the content of the network packet is a PLAY signaling of real time stream protocol.

Preferably, determining whether content of the network packet is signaling indicating the end of the stream transmission includes: determine whether the content of the network packet is a TEARDOWN signaling of the real time stream protocol.

Preferably, the process of identifying the start or end of stream transmission from a content server to a terminal by a network element of the CN includes: analyzing a destination address from a network packet forwarded by the network element of the CN, if the destination address is an address of the content server, analyze content of the network packet, and determine whether content of the network packet is a signaling indicating the start or end of the stream transmission.

The CN network element is preferably the SGSN or the GGSN.

A system for switching traffic during a real time stream transmission includes: a content server which is used for providing a real time stream transmission; a network side which is used for performing a traffic switching from the streaming traffic to the BE traffic when identifying a start of the stream transmission; and performing a traffic switching from the streaming traffic to the BE traffic when identifying an end of the real time stream transmission.

In the system, the network side preferably includes: an SGSN of a CN, sending a request for switching a bearer channel between the BE traffic and the streaming traffic; an RNC of the access network, receiving the request for switching a bearer channel between the BE traffic and the streaming traffic, and performing the switching between the BE traffic and the streaming traffic.

In the system, the content server is preferably further configured to identify the start and the end of the real time stream transmission, and send a request for setting up a streaming traffic bearer or a BE traffic bearer to the SGSN.

In the system, the SGSN is preferably further configured to identify the start and the end of the real time stream transmission, and send a request for switching a bearer channel between the BE traffic and the streaming traffic to the RNC of the access network.

In the system, the network side preferably includes: a GGSN configured to identify the start and the end of the real time stream transmission, and send a request for switching a bearer channel between the BE traffic and the streaming traffic to the RNC of the access network.

A content server for real time stream transmission includes: a first unit, receiving a request for a stream transmission from a terminal and the signaling indicating the end of the stream transmission from the terminal; a second unit, identifying a start and an end of a stream transmission according the request and the signaling received by the first unit; a third unit, sending a request for setting up a streaming traffic bearer or a BE traffic bearer to an SGSN of a CN.

A GGSN for real time stream transmission includes: a first unit, determining whether content of a network packet is signaling indicating a start or an end of a stream transmission; a second unit, sending a request for switching a bearer channel from a BE traffic to a streaming traffic to an SGSN of a CN when the content of the network packet is the signaling indicating the start of the stream transmission, and sending a request for switching the bearer channel from the streaming traffic to the BE traffic to the SGSN of the CN when the content of the network packet is the signaling indicating the end of the stream transmission.

An SGSN for real time stream transmission includes: a first unit, determining whether content of the network packet is signaling indicating a start or an end of a stream transmission; a second unit, sending a request for switching a bearer channel from a BE traffic to a streaming traffic to an access network when the content of the network packet is the signaling indicating the start of the stream transmission; and sending a request for switching the bearer channel from the streaming traffic to the BE traffic to the access network when the content of the network packet is the signaling indicating the end of the stream transmission.

As can be seen from the above solution, the content server is used to notify the CN to perform the switching between the BE traffic and the streaming traffic when the stream media transmission starts or ends in accordance with an embodiment of the invention, or to identify the stream media transmission starts or ends through the method in which the SGSN or the GGSN analyze the signaling, and to perform the switching between the BE traffic and the streaming traffic. The method ensures the QoS of the stream media transmission, which is not necessary for the terminal to identify streaming traffic and notify CN during the traffic switching, thus reduces the requirement for the terminal. The method is easily popularized and applied.

### BRIEF DESCRIPTION OF THE DRAWINGS

FIG. 1 is a schematic diagram illustrating the network architecture in an embodiment of the invention.

FIG. 2 is a flow chart in accordance with Embodiment 1 of the invention.

FIG. 3 is a flow chart in accordance with Embodiment 2 of the invention.

### DETAILED DESCRIPTION OF THE PREFERRED EMBODIMENTS

Embodiments of the invention are described in detail hereinafter with reference to the accompanying drawings to further clarify the objectives, technical solutions and advantages of the embodiments of the invention.

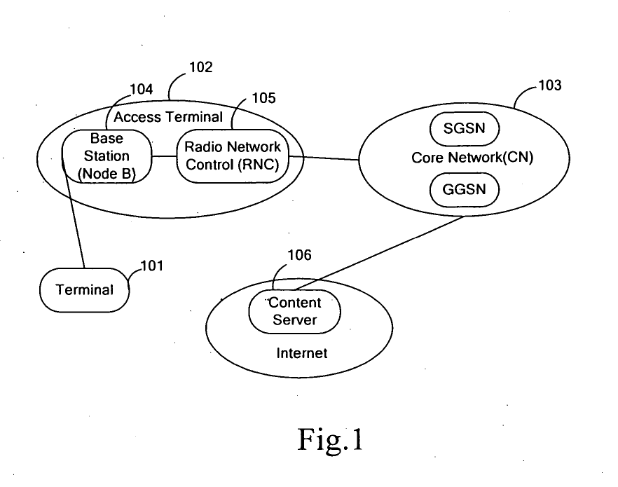

A Wideband Code Division Multiple Access (WCDMA) network system is one of the mainstream networks of the 3G mobile communication systems, adopting the General Packet Radio Service (GPRS) techniques. The schematic diagram illustrating the WCDMA system architecture is shown in FIG. 1, which includes a terminal 101, an access network 102 and a CN 103, wherein the CN 103 connects with the Internet to implement the interaction between the mobile communication network and the Internet. The access network 102 further includes a base station (Node B) 104 and a RNC 105, the CN 103 further includes an SGSN and a GGSN. To play a stream media, there is also a content server 106 in the network, which is called a stream media server, and the stream media or the stream media link is directly placed on the webpage of the content server. The user visits the webpage of the content server 106 in the Internet by the terminal 101 via the access network 103 and the CN 103, to select, click and play the stream media which the user wants to watch. As the visit to the webpage of the content server by the user is an interactive traffic without requirements on rate and time delay, it uses the BE traffic as the bearer. When the user clicks the stream media on the webpage, it is necessary to switch the BE traffic to the streaming traffic to bear the stream media. In embodiments of the invention, the stream media refers to stream, namely real time stream, and the stream media transmission refers to the stream transmission.

According to different initiators of traffic switching, the solution can be implemented in two embodiments, which are the traffic switching performed by the content server and the traffic switching performed by the network element such as the SGSN or the GGSN in the CN.

### Embodiment 1

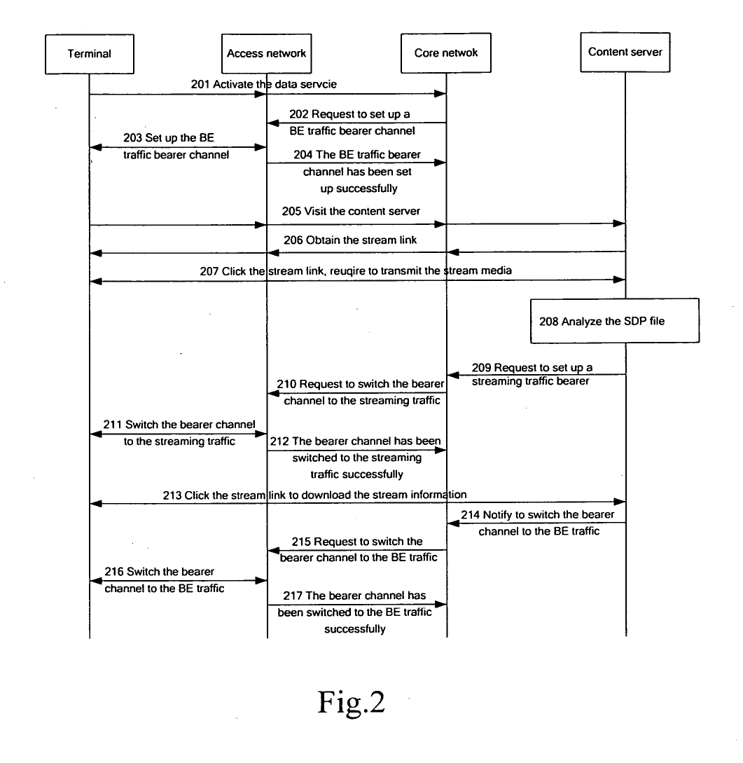

The content server initiates the BE traffic/streaming traffic switching. The flow chart of the embodiment is shown in FIG. 2, which includes the following steps.

Step 201: a terminal sends a request for activating data traffic to a CN via an access network.

Step 202: upon receiving the request, the CN sends a request to the access network for setting up a BE traffic bearer channel.

Step 203: upon receiving the request from the CN, the access network interacts with the terminal to set up the BE traffic bearer channel.

Step 204: the access network sends to the CN a message indicating the BE traffic bearer channel has been set up successfully.

Steps 205 to 206: the terminal visits the content server in the manner of BE traffic bearer to obtain the stream media network link address through the access network and the CN.

Step 207: the terminal visits the stream media network link, and requests the stream media transmission.

Step 208: the content server analyzes the SDP file corresponding to the stream media to be transmitted, and obtains the QoS requirement of the stream media transmission. The SDP file includes: basic information of the session, such as the title and author as well as the type of the stream media, the bandwidth requirement, and etc.

Step 209: the content server sends a request for setting up a streaming traffic bearer to the SGSN of the CN, wherein the request includes the QoS requirement of setting up the streaming traffic. The SGSN activates the PDP context by interacting with the GGSN, and authenticates the terminal user.

Step 210: if the authentication is successful, the CN sends to the RNC of the access network a request for switching the bearer channel from the BE traffic to the streaming traffic.

Step 211: upon receiving the request, the access network interacts with the terminal to switch the bearer channel from the BE traffic to the streaming traffic.

Step 212: the access network notifies the SGSN in the CN that the bearer channel has been switched to the streaming traffic successfully.

Step 213: the terminal sends a PLAY signaling of the Real-Time Streaming Protocol (RTSP) to the content server, upon receiving the PLAY signaling, the content server transmits the stream media to the terminal via the streaming traffic bearer channel.

Step 214: when the stream media transmission is finished, the terminal sends to the content server a TEARDOWN signaling of RTSP for terminating the stream media transmission; upon receiving the TEARDOWN signaling, the content server sends a request for setting up a BE traffic bearer to the SGSN in the CN.

Step 215: the SGSN in the CN sends to the RNC of the access network a request for switching the bearer channel from the streaming traffic to the BE traffic.

Step 216: upon receiving the request, the access network interacts with the terminal to switch the bearer channel to the BE traffic.

Step 217: the access network notifies the SGSN in the CN that the bearer channel has been switched to the BE traffic successfully, and terminates the current traffic flow.

### Embodiment 2

The CN initiates the BE traffic/streaming traffic switching.

In this embodiment, network element of the CN, for example, an SGSN or a GGSN analyzes network packet sent to a content server by a terminal. When determining that stream media transmission is about to start according to the contents of the network packet, the network element of the CN switches the bearer channel from the BE traffic to the streaming traffic. When determining the stream media transmission is about to end from the contents of the network packet, the network element of the CN switches the bearer channel from the streaming traffic to the BE traffic. Therefore the embodiment requires the SGSN or the GGSN to analyze and identify the network packet, and the analyzing step can be divided into two steps:
Step 1, analyzing a destination address of a forwarded network packet, and determining whether the destination address is the address of the content server. If the destination address is the address of the content server, proceed to Step 2; otherwise, forward the network packet;
Step 2, further analyzing the content of the network packet, determining whether the content is a PLAY signaling or a TEARDOWN signaling which both belongs to the RTSP; if the content is a PLAY signaling, the SGSN or the GGSN initiates the switching from the BE traffic to the streaming traffic; if the content is a TEARDOWN signaling, the SGSN or the GGSN initiates the switching from the streaming traffic to the BE traffic. If the content of the network packet is neither of the two kinds of signaling, forward the network packet.

The start or end of the stream media transmission is determined by identifying a PLAY signaling or a TEARDOWN signaling in the Step 2 mentioned above, which can also be determined by identifying other kinds of signaling indicating the start or end of the stream media or other characteristic information.

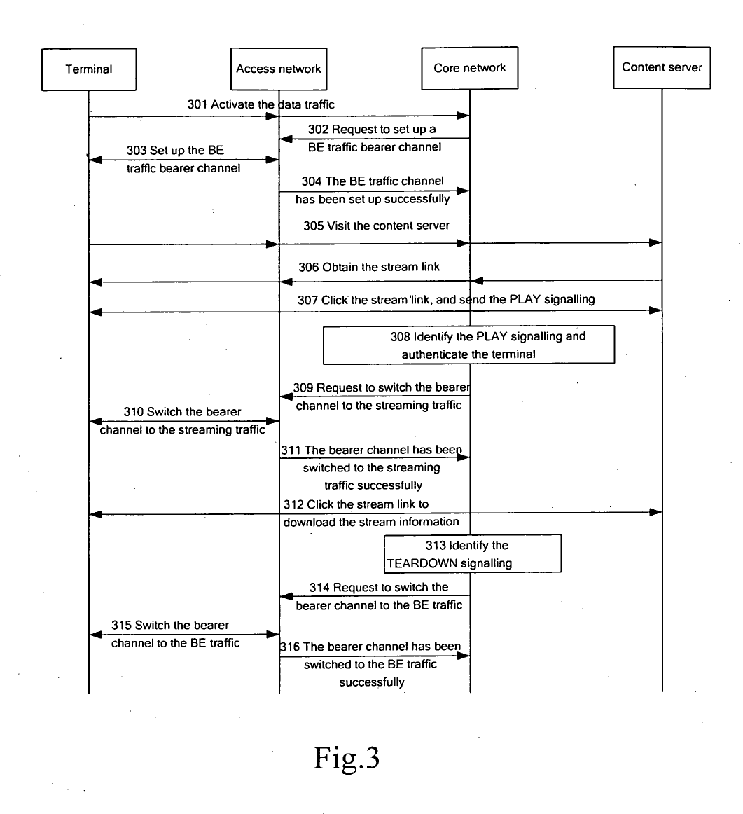

The flow chart of this embodiment is shown in FIG. 3, which includes the following steps.

Step 301: a terminal sends a request for activating data traffic to a CN via an access network.

Step 302: upon receiving the request, the CN sends a request to the access network for setting up a BE traffic bearer channel.

Step 303: upon receiving the request from the CN, the access network interacts with the terminal to set up the BE traffic bearer channel.

Step 304: the access network sends to the CN a message indicating the BE traffic bearer channel has been set up successfully.

Steps 305 to 306: the terminal visits the content server in the manner of the BE traffic bearer to obtain a stream media network link address via the access network and the CN.

Step 307: the terminal visits the stream media network link, and sends a RTSP PLAY signaling to the content server.

Step 308: the SGSN or the GGSN determines that the signaling sent to the content server from the terminal is the PLAY signaling by analyzing and identifying the network packet, obtains and analyzes the SDP file corresponding to the stream media from the content server, and obtains the QoS requirement of the stream media transmission. The content of the SDP file includes basic information of the session such as the title and author, the type of the stream media, the bandwidth requirement, and etc. The SGSN activates the PDP context through interacting with the GGSN, and authenticates the terminal user.

Step 309: if the authentication is successful, the SGSN of the CN sends to the RNC of the access network a request for switching the bearer channel from the BE traffic to the streaming traffic.

Step 310: upon receiving the request, the access network interacts with the terminal to switch the bearer channel from the BE traffic to the streaming traffic.

Step 311: the access network notifies the SGSN of the CN that the bearer channel has been switched to the streaming traffic successfully.

Step 312: the content server transmits the stream media to the terminal via the established streaming traffic bearer channel.

Step 313: when the stream media transmission is finished, the terminal sends a RTSP TEARDOWN signaling to terminate the stream media transmission to the content server, the SGSN of the CN or the GGSN of the CN determines the signaling sent to the content server by the terminal is a TEARDOWN signaling by analyzing and identifying the network packet.

Step 314: the SGSN of the CN sends to the RNC of the access network a request for switching the bearer channel from the streaming traffic to the BE traffic.

Step 315: upon receiving the request, the access network interacts with the terminal to switch the bearer channel to the BE traffic.

Step 316: the access network notifies the SGSN of the CN that the bearer channel has been switched to the BE traffic successfully.

The foregoing describes only preferred embodiments of the invention and is not to limit the invention. Any modification, equivalent substitution, and improvement without departing from the spirit and principle of the invention should be covered in the protection scope of the invention.

What is claimed is:

1. A method for switching traffic during a real time stream transmission comprising:
upon identifying a start of stream transmission from a content server to a terminal, a traffic being switched by a network side from a Best Effort (BE) traffic to a streaming traffic, and
upon identifying an end of stream transmission from the content server to the terminal, the traffic being switched by the network side from the streaming traffic to the BE traffic.

2. The method of claim 1, wherein the identifying the start of stream transmission from a content server to a terminal is implemented by the content server;
the traffic being switched from the BE traffic to the streaming traffic comprises:
upon receiving a request for the stream transmission from the terminal and identifying the start of the stream transmission, sending a request for setting up a streaming traffic bearer to a Serving General Packet Radio Service (GPRS) Support Node (SGSN) of a Core Network (CN);
upon receiving the request for setting up the streaming traffic bearer, sending a request for switching a bearer channel from the BE traffic to the streaming traffic to a Radio Network Control (RNC) of an access network;
upon receiving the request for switching the bearer channel, interacting with the terminal to switch the bearer channel from the BE traffic to the streaming traffic.

3. The method of claim 1, wherein said identifying the end of stream transmission from a content server to a terminal is implemented by the content server;
the traffic being switched from the streaming traffic to the BE traffic comprises:
upon receiving signaling indicating the end of stream transmission from the terminal and identifying the end of the stream transmission, sending a request for setting up a BE traffic bearer to the SGSN of the CN;
upon receiving the request for setting up the BE traffic bearer, sending a request for switching the bearer channel from the streaming traffic to the BE traffic to the RNC of an access network;
upon receiving the request for switching the bearer channel, interacting with the terminal to switch the bearer channel to the BE traffic.

4. The method of claim 3, wherein the signaling indicating the end of stream transmission is a TEARDOWN signaling of the real time stream protocol.

5. The method of claim 2, further comprising: before sending the request for setting up the streaming traffic bearer to the SGSN of the CN, obtaining the Quality of Service (QoS) requirement of the stream transmission from a session description protocol file corresponding to the stream, and the QoS requirement being contained in the request for setting up the streaming traffic bearer.

6. The method of claim 3, further comprising: before sending the request for setting up the streaming traffic bearer to the SGSN of the CN, obtaining the QoS requirement of the stream transmission from a session description protocol file corresponding to the stream and, the QoS requirement being contained in the request for setting up the streaming traffic bearer.

7. The method of claim 1, wherein said identifying the start of stream transmission from a content server to a terminal is implemented by a network element of the CN;
the traffic being switched from the BE traffic to the streaming traffic comprises:
determining whether content of a network packet sent to the content server is a signaling indicating the start of the stream transmission, if the content of the network packet is the signaling indicating the start of the stream transmission, sending a request for switching a bearer channel from the BE traffic to the streaming traffic to an RNC of an access network;
upon receiving the request for switching the bearer channel, interacting with a terminal to switch the bearer channel from the BE traffic to the streaming traffic.

8. The method of claim 1, wherein said identifying the end of stream transmission from a content server to a terminal is implemented by a network element of the CN;
the traffic being switched from the streaming traffic to the BE traffic comprises:
determining whether content of the network packet sent to the content server is a signaling indicating the end of the stream transmission, if the content of the network packet is the signaling indicating the end of the stream transmission, sending a request for switching the bearer channel from the streaming traffic to the BE traffic to the RNC of the access network;
upon receiving the request for switching the bearer channel, interacting with the terminal to switch the bearer channel to the BE traffic.

9. The method of claim 7, wherein the determining whether the content of the network packet is signaling indicating the start of the stream transmission comprises:
determining whether the content of the network packet is a PLAY signaling of real time stream protocol.

10. The method of claim 8, wherein the determining whether content of the network packet is signaling indicating the end of the stream transmission comprises:
determining whether the content of the network packet is a TEARDOWN signaling of the real time stream protocol.

11. The method of claim 7, wherein said identifying the start of stream transmission from a content server to a terminal by a network element of the CN comprises:
analyzing a destination address from a network packet forwarded by the network element of the CN, and if the destination address is an address of the content server, analyzing content of the network packet, and determining whether content of the network packet is a signaling indicating the start of the stream transmission.

12. The method of claim 8, wherein said identifying the end of stream transmission from a content server to a terminal by a network element of the CN comprises:
analyzing a destination address from a network packet forwarded by the network element of the CN, and if the destination address is an address of the content server, analyzing content of the network packet, and determining whether content of the network packet is a signaling indicating the end of the stream transmission.

13. The method of claim 7, wherein the network element of the CN is the SGSN.

14. The method of claim 8, wherein the network element of the CN is the SGSN.

15. The method of claim 7, wherein the network element of the CN is a Gateway General Packet Radio Service Supporting Node (GGSN).

16. The method of claim 8, wherein the network element of the CN is a GGSN.

17. A system for switching traffic during a real time stream transmission comprsing:
a content server, providing a real time stream transmission;
a network side, performing a traffic switching from a streaming traffic to a Best Effort (BE) traffic when identifying a start of the stream transmission; and performing a traffic switching from the streaming traffic to the BE traffic when identifying an end of the real time stream transmission.

18. The system of claim 17, wherein the network side comprises:
a Serving General Packet Radio Service (GPRS) Support Node (SGSN) of a Core Network (CN) which is used for sending a request for switching a bearer channel between the BE traffic and the streaming traffic; and
a Radio Network Control (RNC) of the access network which is used for receiving the request for switching a bearer channel between the BE traffic and the streaming traffic, and is used for performing the switching between the BE traffic and the streaming traffic.

19. The system of claim 18, wherein the content server is further configured to identify the start and the end of the real time stream transmission, and send a request for setting up a streaming traffic bearer or a BE traffic bearer to the SGSN.

20. The system of claim 18, wherein the SGSN is further configured to identify the start and the end of the real time stream transmission, and send a request for switching a bearer channel between the BE traffic and the streaming traffic to the RNC of the access network.

21. The system of claim 18, wherein the network side comprises a Gateway General Packet Radio Service Supporting Node (GGSN), configured to identify the start and the end of the real time stream transmission, and send a request for switching a bearer channel between the BE traffic and the streaming traffic to the RNC of the access network.

22. A content server for real time stream transmission comprising:
a first unit, receiving a request for a stream transmission from a terminal and the signaling indicating the end of the stream transmission from the terminal;
a second unit, identifying a start and an end of a stream transmission according the request and the signaling received by the first unit;
a third unit, sending a request for setting up a streaming traffic bearer or a Best Effort (BE) traffic bearer to a Serving General Packet Radio Service (GPRS) Support Node (SGSN) of a core network (CN).

23. A Gateway General Packet Radio Service Supporting Node (GGSN) for real time stream transmission comprising:
a first unit, determining whether content of a network packet is signaling indicating a start or an end of a stream transmission;
a second unit, sending a request for switching a bearer channel from a Best Effort (BE) traffic to a streaming traffic to a Serving General Packet Radio Service (GPRS) Support Node (SGSN) of a core network (CN) when the content of the network packet is the signaling indicating the start of the stream transmission, and sending a request for switching the bearer channel from the streaming traffic to the BE traffic to the SGSN of the CN when the content of the network packet is the signaling indicating the end of the stream transmission.

24. A Serving General Packet Radio Service (GPRS) Support Node (SGSN) for real time stream transmission comprising:
a first unit, determining whether content of the network packet is signaling indicating a start or an end of a stream transmission;
a second unit, sending a request for switching a bearer channel from a Best Effort (BE) traffic to a streaming traffic to an access network when the content of the network packet is the signaling indicating the start of the stream transmission; and sending a request for switching the bearer channel from the streaming traffic to the BE traffic to the access network when the content of the network packet is the signaling indicating the end of the stream transmission.
